(19) United States
(12) Patent Application Publication
(10) Pub. No.: US 2015/0014882 A1
(43) Pub. Date: Jan. 15, 2015

(54) METHOD OF FORMING MOLDED COMPONENTS

(71) Applicant: No Limit Safety, LLC, Pittsburg, KS (US)

(72) Inventor: Tom Darnell, Wellsville, KS (US)

(21) Appl. No.: 14/328,934

(22) Filed: Jul. 11, 2014

Related U.S. Application Data
(60) Provisional application No. 61/845,799, filed on Jul. 12, 2013.

(51) Int. Cl. B29C 45/16; B22D 17/00; A61H 99/00; B29C 45/14

(52) U.S. Cl. CPC B29C 45/1671; B29C 45/14819; B22D 17/007; A61H 99/00; B29C 2045/1673; B29L 2009/003
USPC 264/250

(57) ABSTRACT

A method of forming a hybrid injection molded component in which a metal core is formed and a chemically inert outer shell is formed over the metal core. The metal core material is thixotropically injected into a first mold, cooled, and removed from the first mold. The metal core is then inserted into a second mold and held in place with pin locators. Thermoplastic material is injected into a gap between the metal core and the second mold so as to form the outer shell. The pin locators are retracted and the thermoplastic material is allowed to fill in the spaces previously occupied by the pin locators.

### CROSS REFERENCE TO RELATED APPLICATION

This non-provisional patent application claims priority to U.S. Provisional Patent Application No. 61/845,799 filed on Jul. 12, 2013, the entire contents of which is herein incorporated by reference in its entirety.

### BACKGROUND

The present invention relates to a method of forming hybrid molded components.

Molded components may be formed via several injection molding processes. For example, magnesium components can be formed via a thixotropic injection molding process in which chipped magnesium alloys are fed into the barrel of an injection molding machine where the alloy chips are brought to a high temperature and held in a semi-solid state. The accumulated semi-solid slurry is then subjected to high sheer forces in the screw and barrel of the injection molded machine as the slurry is injected into the mold at a high rate. The sheer forces cause the magnesium semi-solid slurry to flow thixotropically into the mold under extreme injection pressure. The slurry is then held under pressure and cooled to form the finished component.

Thixotropic injection molding has a number of benefits such as being faster and safer than die casting. A thixotropically injected component has low voids, relatively high strength, and more elongation due to a much finer grain structure than other molding processes. The low voids and fine grain structure lead to higher accuracy of the shape of the finished part. However, many metals used in the thixotropic injection molding process such as magnesium are very susceptible to galvanic corrosion when fastened to other metals. This makes fastening other components to the magnesium component difficult and compromises structural integrity. The magnesium component must also have a boundary coating before being painted so that the paint will adhere to the component and will not corrode. The boundary coating is often more expensive than the cost of the uncoated component itself.

Thermoplastic components can be formed via a similar conventional injection molding process. The plastic is reinforced with substrates and fillers to increase its stiffness and strength. Thermoplastic components are easy to form and can be made to have high resistance to environmental exposure and chemical exposure. However, even the strongest thermoplastic components are limited to mechanical stiffness of less than 2.5 MPSI. To reach this stiffness, the plastics have fillers such as glass and carbon-fiber in large amounts ranging from 15% to 60% of the material by volume. Elongation is lost as strength and stiffness are gained through fillers, so additives called toughening agents (synthetic rubbers) are introduced to provide additional elongation. The toughening agents generally constitute 1% to 3% of the material composition by volume. Nevertheless, a thermoplastic component may have a density of only 1.5 g/cc to 1.7 g/cc, a mechanical stiffness of only 0.8 MPSI to 2.5 MPSI, a tensile strength of 18 MPSI to 38 MPSI, and an elongation of only 0.5% to 4%, compared to a thixotropically molded magnesium component, which may have a density of 1.68 g/cc to 1.78 g/cc, a mechanical stiffness of approximately 6 MPSI, a tensile strength of 23 MPSI to 38 MPSI, and an elongation of 1% to 15%. The raw material used in a thermoplastic component is also more expensive than the alloys used in a magnesium thixotropic injection molded component.

Accordingly, there is a need for an improved method of forming a molded component that overcomes the above-described limitations of the prior art.

### SUMMARY

The present invention solves the above-described problems and provides a distinct advance in the art of injection molding. More particularly, the present invention provides a method of forming a hybrid injection molded component in which a metal core is formed and a chemically inert outer shell is formed over the metal core.

A modified injection molding machine and a coating injection molding tool are used to form the hybrid injection molded component. The modified injection molding machine includes a first mold having a tooling cavity shaped to form a desired outer shape of the metal core. The coating injection molding tool includes a second mold having a tooling cavity shaped to form a desired outer shape of the completed hybrid component. The second mold includes pin locators for positioning the metal core in the tooling cavity of the second mold.

The metal core is formed by melting a supply of metal such as magnesium alloy to a semi-solid state, injecting the melted metal into the tooling cavity of the first mold, and cooling the metal to a solid state. The melted metal conforms to the contours of the tooling cavity and cools so as to make a structural core shape.

The outer shell is formed by inserting the metal core into the tooling cavity of the second mold and spacing the metal core from the mold contours so as to form a small gap between the metal core and the mold contours. Pin locators are inserted into the tooling cavity against the metal core to hold the metal core in place. A thermoplastic material is then injected into the gap between the metal core and the mold contours so as to partially or completely fill in the gap. The pin locators are then removed or retracted to allow the thermoplastic material to fill in the spaces previously occupied by the pin locators. The thermoplastic material solidifies around the metal core to form the hybrid component, which is then removed from the tooling cavity of the second mold.

Forming a hybrid injection molded component as described above provides numerous advantages. For example, the metal core provides stiffness and strength to the hybrid component. The outer shell provides an inert barrier coating, abrasion resistance, chemical corrosion resistance, additional structural support, and sound deadening.

Another embodiment of the present invention is a method of forming a head and neck (HANS) device including a central brace and left and right legs having corresponding connection points. The central brace and the left and right legs of the HANS device are formed using the above-described method and then connected together at the connection points.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevation view of a conventional thixotropic injection molding machine that may be used to implement aspects of the present invention;

FIG. 2 is a perspective view of a hybrid molded component constructed in accordance with an embodiment of the present invention;

FIG. 3 is a perspective view of the central brace of a head and neck support (HANS) device;

FIG. 4 is a sectional view of the central brace of FIG. 3; and

FIG. 5 is a sectional view of the central brace of FIG. 3 being held in the mold of a coating injection molding tool.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present invention provide a method of forming a hybrid injection molded component 10 having a metal core 12 and a chemically inert outer shell 14 formed over the metal core 12. Turning to the figures, a modified injection molding machine 16 may be used to form the metal core 12 and a coating injection molding tool may be used to form the outer shell 14.

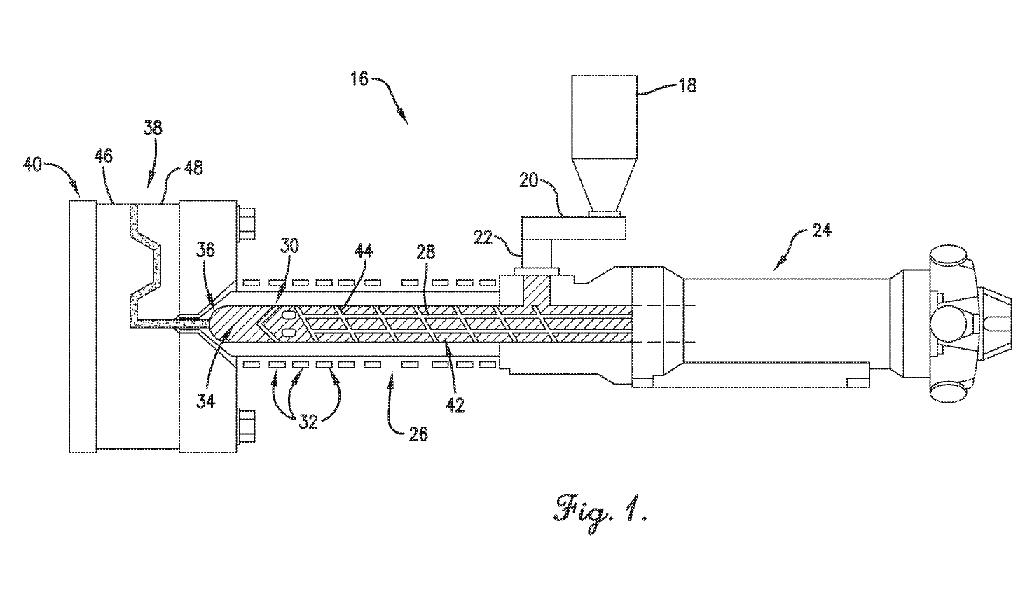

An embodiment of the injection molding machine 16 includes a feedstock 18, a feeder 20, an argon atmosphere conduit 22, a rotary drive and shot system 24, a barrel 26, a reciprocating screw 28, a non-return valve 30, a number of band heaters 32, a thixotropic shot accumulator 34, a nozzle 36, a first mold 38, and a die clamp 40, as shown in FIG. 1.

The feedstock 18 holds a supply of magnesium alloy chips such as elemental magnesium, AM60b magnesium alloy, or other metal or metal composite and is positioned at a high point of the injection molding machine 16 so that the magnesium alloy chips are gravity fed into the feeder 20.

The feeder 20 propels the magnesium alloy chips (i.e., injection material) from the bottom of the feedstock 18 into the argon atmosphere conduit 22 and into the barrel 26 via the conduit 22.

The argon atmosphere conduit 22 connects the feeder 20 to the barrel 26 and is filled with argon so that temperature, pressure, and other parameters are easier to control and to prevent unwanted gases from mixing with the injection material.

The rotary drive and shot system 24 turns the reciprocating screw 28 to draw injection material into the barrel 26, retracts the reciprocating screw 28, and projects the reciprocating screw 28 into the barrel 26 to force the injection material into the first mold 38.

The barrel 26 encloses the reciprocating screw 28 in an internal channel 42 and guides the injection material from the argon atmosphere conduit 22 and into the first mold 38 through the internal channel 42.

The reciprocating screw 28 rotates inside the internal channel 42 of the barrel 26 and includes a helical thread 44 for drawing injection material into the internal channel 42 as the reciprocating screw 28 is rotated.

The non-return valve 30 prevents the backflow of injection material into the internal channel 42 once the injection material is forced into the first mold 38.

The band heaters 32 heat the injection material in the barrel 26 to a semi-solid slurry before being injected into the first mold 38.

The thixotropic shot accumulator 34 is a space at the end of the barrel 26 wherein injection material collects until the reciprocating screw 28 forces the injection material into the first mold 38.

The nozzle 36 channels the injection material into the first mold 38 through a small diameter opening. The nozzle 36 gradually narrows from the width or diameter of the internal channel 42 of the barrel 26 to the width or diameter of the small opening to ensure optimal flow of the injection material through the nozzle 36.

The first mold 38 forms the injection material into the shape of the metal core and includes two or more blocks 46, 48 with contours that cooperatively form a tooling cavity when the blocks 46, 48 are pressed together.

The die clamp 40 retains the blocks 46, 48 of the first mold 38 together when the metal core is being formed.

The coating injection molding tool is substantially similar to the modified injection molding machine 16 except the coating injection molding tool injects thermoplastic material and includes a second mold 50 (instead of the first mold 38) for injecting thermoplastic material. The thermoplastic material can be any polymer or plastic material such as DuPont MT409 Toughened Nylon.

The second mold 50 forms the thermoplastic injection material into the shape of the finished hybrid component around the metal core and includes two or more blocks 52, 54 and a number of retractable pin locators 56, 58.

The blocks 52, 54 have contours 60 that cooperatively form a tooling cavity 62 when the blocks 52, 54 are pressed together.

Forming the metal core 12 of the hybrid component 10 will now be described in more detail. The feeder 20 feeds a supply of chipped magnesium alloy particles or other metal (i.e., the injection material) from the feedstock 18, through the argon atmosphere conduit 22, and into the barrel 26. Meanwhile, the rotary drive and shot system 24 rotates the reciprocating screw 28 and retracts the reciprocating screw 28 away from the thixotropic shot accumulator 34 so that the injection material collects in the thixotropic shot accumulator 34. The band heaters 32 also bring the injection material up to a predetermined temperature so as to melt the injection material to a semi-solid slurry mixture ranging between 0.01% solid to 30% solid. The rotary drive and shot system 24 then pushes the reciprocating screw 28 towards the thixotropic shot accumulator 34 so that the injection material is forced through the nozzle 36 and into the tooling cavity of the first mold 38 at a high rate. The injection material is subjected to high sheer forces during this maneuver, which causes the injection material to flow thixotropically into the first mold 38. The injection material is held under pressure and cooled in the first mold 38 to form the metal core. Once the metal core 12 has solidified, the blocks 46, 48 of the first mold 38 are separated and the metal core 12 is ejected or removed.

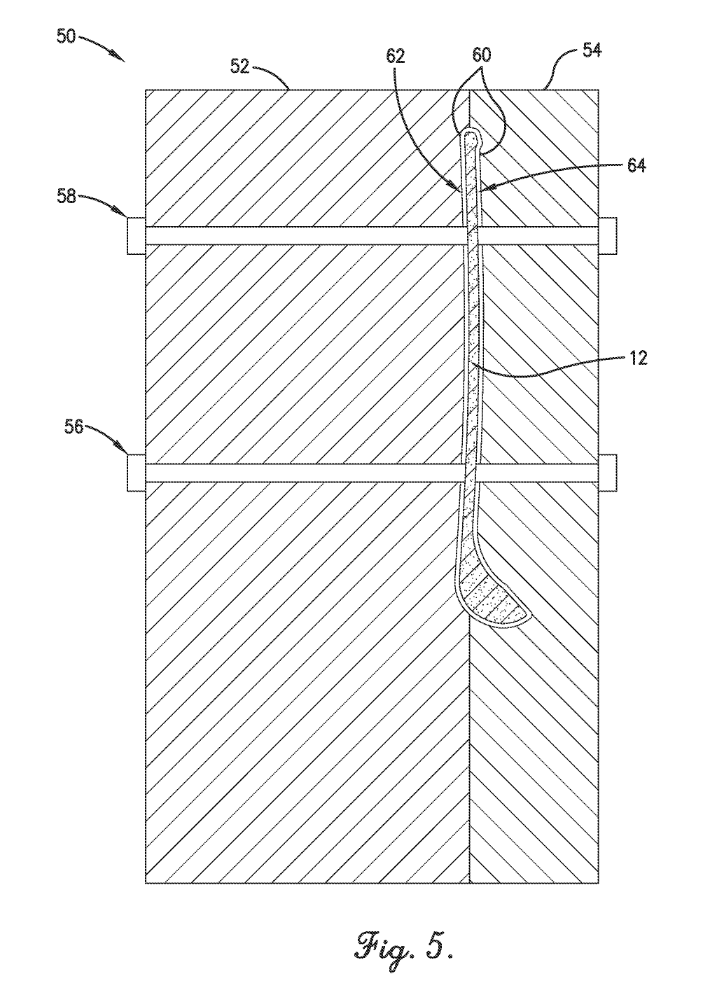

Forming the outer shell 14 over the metal core 12 will now be described in more detail. The metal core 12 is positioned between the blocks 52, 54 in the tooling cavity 60 of the second mold 50 at room temperature and held in place by the retractable pin locators 56, 58, as shown in FIG. 5. The retractable pin locators 56, 58 extend slightly into the tooling cavity 60 so as to form a gap 64 between the metal core 12 and the blocks 52, 54 of the second mold 50. The gap 64 may have a gradually changing thickness or may have a uniform thickness of between 0.01 and 0.1 inches over at least a substantial portion thereof. The uniform gap thickness allows injection molding pressure to be relatively even within the tooling cavity 60 during material injection. The gap 64 may be substantially thicker in certain areas (e.g., up to 1 inch) where core strength is not needed but a specific component shape is desired. In addition, the gap 64 may be significantly larger in certain locations so as to form external features such as mounting bosses, locators, low load attachment points, ribbing, guides, cams, aesthetic features, and other features. Similarly, the gap 64 may be closed in certain locations such as at connector pegs 108, 110 (described below) so as to expose the metal core 12 for connecting other components directly to the metal core 12.

With the blocks 52, 54 pressed together, heated thermoplastic material is rapidly injected into the tooling cavity 60 and is allowed to flow around the metal core 12 so as to partially or completely encapsulate the metal core 12. Once the gap 64 is filled or almost filled so that the thermoplastic material can substantially hold the metal core 12 in place and before the thermoplastic material has solidified, the pin locators 56, 58 are retracted, which allows the thermoplastic material to flow into the spaces previously occupied by the pin locators 56, 58. Encapsulating the metal core 12 with thermoplastic material takes less than 40 seconds and may take 35 seconds or less. The thermoplastic material is then allowed to cool and solidify around the metal core 12. The blocks 52, 54 of the second mold 50 are then separated and the hybrid component 10 is removed from the second mold 50.

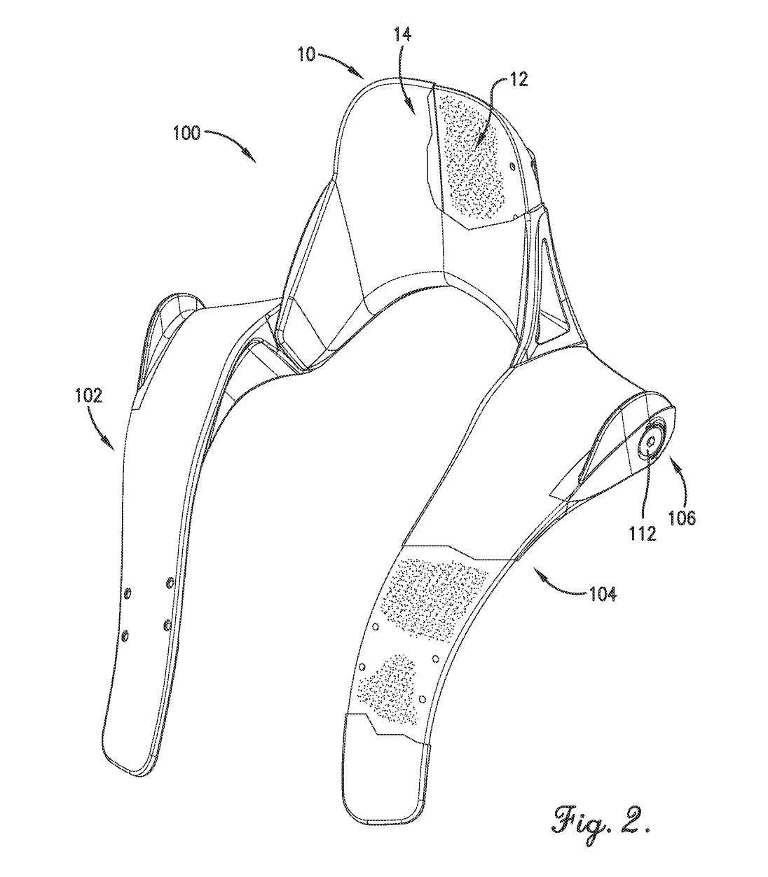

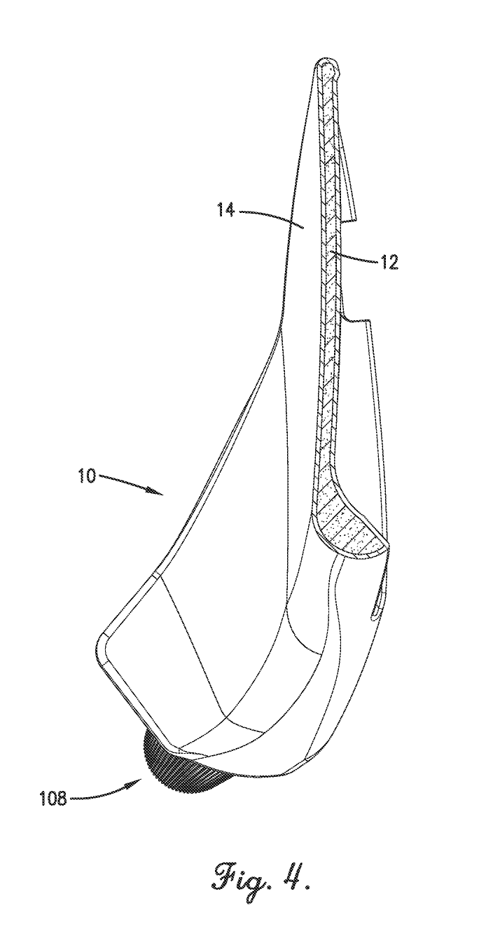

The above-described method of forming a hybrid injection molded component 10 provides several advantages over conventional injection molding techniques. For example, the hybrid injection molded component 10 exhibits high specific stiffness and high specific strength. The component 10 can have precise geometry with complex shapes, thin cross sections, and complex ribbing, as shown in FIGS. 2-4. Thixotropically forming the metal core 12 allows for high process control and reduces voids in the metal core 12, which results in consistent strength and stiffness. This allows for improved structural optimization for the required load and allows the component 10 to provide localized strength throughout its structure. Replacing low load or no load areas with the thermoplastic material reduces the overall weight of the structure. Thermoplastic component extremities also contribute strength and stiffness due to the increased moment of inertia. For example, a hybrid component optimized to 50% magnesium and 50% nylon shell, where the magnesium metal core has a specific gravity of 1.7 g/cc and a tensile strength of 28,000 psi, and where the nylon shell has a specific gravity of 1.09 g/cc and a tensile strength of 9000 psi, results in an 18% weight reduction.

The present invention also results in a component 10 having a high crash worthiness due to the high elongation of the metal core 12. For crash worthiness, part elongation or bending is essential in absorbing energy during impact and preventing fragmentation. The thixotropically injected metal core 12 exhibits high elongation of between 13% and 20% in both hot and cold weather, compared to less than 6% for die cast metal and less than 4% for thermoplastics. As such, the hybrid injection molded component 10 will outperform die cast and super structural composites in both hot and cold weather impacts.

The present invention further results in a component 10 with low sound characteristics. For example, the outer shell 14 acts as a sound insulator, which completely deadens the part when excited, which reduces sound transmittance. This is important for developing automobiles and related products where transmittance of sound should be minimized.

In addition, the relatively cool temperature of the metal core 12 and the relatively high thermal conductivity of the metal core 12 also allow the thermoplastic outer shell 14 to cool from the inside out, which causes thermoplastic material to shrink to fit the metal core 12. The internal cooling reduces solidification time, which reduces manufacturing cycle times and makes the components more cost effective to produce.

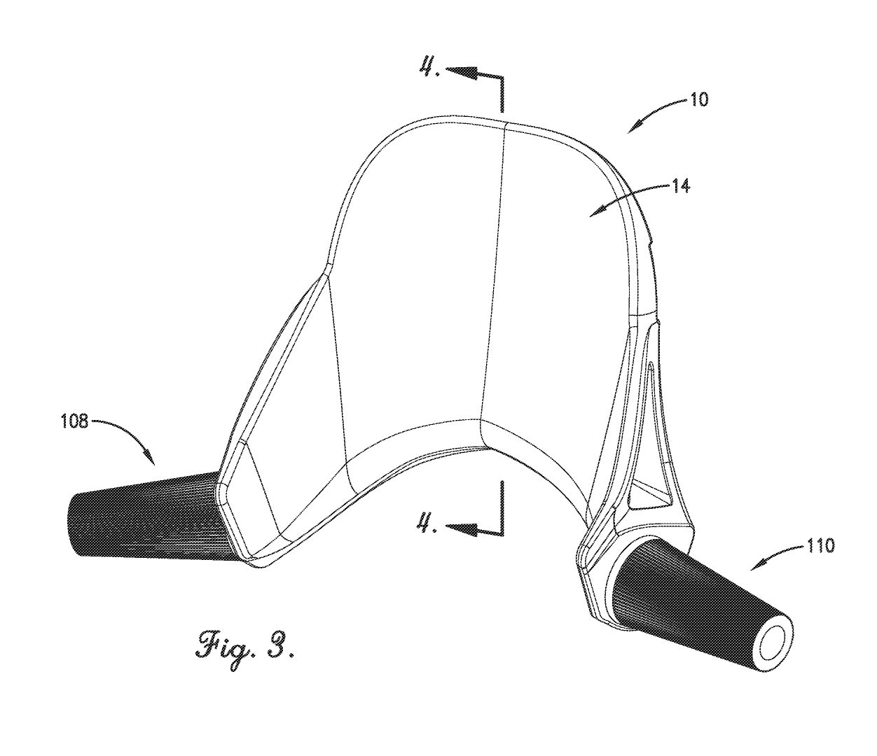

Another embodiment of the invention is a method of forming a head and neck support (HANS) device 100. The HANS device 100 includes a center brace (shown as component 10 described above) and left and right arms 102, 104. The center brace includes connector pegs 108, 110 that are not covered by the outer shell 14 (FIG. 3). The connector pegs 108, 110 have longitudinally extending ridges that interlock with ridges of the left and right arms for angularly setting the left and right arms 102, 104. The connector pegs 108, 110 taper inward (i.e., a conical or semi-conical shape) so that the left and right arms 102, 104 can be easily guided onto the connector pegs 108, 110.

The left and right arms 102, 104 are formed using substantially the same method as described above. The left and right arms 102, 104 each include an inwardly tapered connection hole 106 for inserting the connector pegs 108, 110 of the center brace 10 therein and for receiving a fastener 112 therethrough.

The HANS device 100 is assembled by guiding the left and right arms 102, 104 onto the connector pegs 108, 110 at an angle comfortable for the wearer. The angle can be changed by spacing the left and right arms 102, 104 away from the center brace 10 so that the interlocking ridges of the connector pegs 108, 110 and the connection holes 106 are separated. The left and right arms 102, 104 can then be rotated to the desired angle and then pushed toward the center brace 10 so that the interlocking ridges of the connector pegs 108, 110 and the connection holes 106 engage again. The fasteners 112 are then tightened to lock the left and right arms 102, 104 in place, as shown in FIG. 2.

The HANS device 100 exhibits the advantageous properties described above, which increases the safety and comfort imparted on the wearer. For example, the reduced weight and material used allows the wearer more freedom to move and to react to driving situations. The non-corroding outer shell 14 also prevents loss of structural integrity of the HANS device 100 due to corrosion of stress-bearing metal. The sound deadening outer shell 14 also prevents unnecessary noise from vibrations during racing.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of forming a hybrid component, the method comprising the steps of:
melting a supply of corrosive metal to a semi-solid state;
injecting the corrosive metal into a tooling cavity of a first mold while the corrosive metal is in the semi-solid state, the first mold being shaped to form a desired outer shape of a corrosive metal core;
cooling the corrosive metal to a solid state so as to form a structural sub-component;
inserting the structural sub-component into a tooling cavity of a second mold shaped to form a desired outer shape of the hybrid component;
spacing the structural sub-component from internal sides of the second mold so as to form a gap between the structural sub-component and the internal sides of the second mold;
injecting a chemically inert coating into the gap so as to form a chemically inert, non-structural shell at least partially encapsulating the structural sub-component;
allowing the chemically inert coating to solidify around the structural sub-component; and
removing the at least partially encapsulated structural sub-component from the tooling cavity of the second mold.

2. The method of claim 1, wherein the corrosive metal is a magnesium alloy.

3. The method of claim 1, wherein the corrosive metal includes chipped particles.

4. The method of claim 1, wherein the corrosive metal is between 0.01 percent and 30 percent solid when held in the semi-solid state.

5. The method of claim 1, wherein the chemically inert coating is a thermoplastic material.

6. The method of claim 5, wherein the thermoplastic material is nylon.

7. The method of claim 1, wherein the step of injecting the corrosive metal includes thixotropically injecting the corrosive metal into the tooling cavity of the first mold.

8. The method of claim 1, wherein the step of injecting the chemically inert coating includes the step of allowing the chemically inert coating to flow completely around the structural sub-component so as to fully encapsulate the structural sub-component.

9. The method of claim 1, wherein the gap has a uniform thickness so that injection molding pressure is evenly distributed around the structural sub-component.

10. The method of claim 1, further comprising the step of holding the structural sub-component in the second mold via pin locators.

11. The method of claim 10, further comprising the steps of retracting the pin locators before the chemically inert coating solidifies and allowing the chemically inert coating to flow into spaces previously occupied by the pin locators.

12. The method of claim 1, wherein the structural sub-component is configured to absorb heat from the chemically inert coating so that the chemically inert coating shrinks onto the structural sub-component.

13. The method of claim 1, wherein the steps of inserting the structural sub-component into the tooling cavity, spacing the structural sub-component from internal sides of the second mold, injecting the chemically inert coating into the gap, allowing the chemically inert coating to solidify, and removing the structural sub-component take less than 40 seconds.

14. The method of claim 13, wherein the steps of inserting the structural sub-component into the tooling cavity, spacing the structural sub-component from internal sides of the second mold, injecting the chemically inert coating into the gap, allowing the chemically inert coating to solidify, and removing the structural sub-component take 35 seconds.

15. The method of claim 1, further comprising the step of forming at least one non-structural core portion of the hybrid component via the non-structural shell.

16. The method of claim 1, further comprising the step of forming at least one external non-structural geometric feature of the hybrid component via the non-structural shell.

17. The method of claim 16, wherein the at least one non-structural geometric feature includes a geometric locator.

18. The method of claim 16, wherein the at least one non-structural geometric feature includes an aesthetic feature.

19. The method of claim 16, wherein the at least one non-structural geometric feature includes a low-load attachment.

20. A method of forming a hybrid component, the method comprising the steps of:
melting a supply of corrosive chipped magnesium alloy to a semi-solid state of between 0.01 percent to 30 percent solid;
injecting the corrosive magnesium into a tooling cavity of a first mold while the corrosive magnesium metal is in the semi-solid state, the first mold being shaped to form a desired outer shape of a corrosive metal core;
cooling the corrosive magnesium to a solid state so as to form a structural sub-component;
inserting the structural sub-component into a tooling cavity of a second mold shaped to form a desired outer shape of the hybrid component;
spacing the structural sub-component from internal sides of the second mold so as to form a gap between the structural sub-component and the internal sides of the second mold;
holding the structural sub-component via pin locators;
injecting a thermoplastic coating into the gap so as to form a chemically inert, non-structural shell at least partially encapsulating the structural sub-component;
allowing the thermoplastic coating to solidify around the structural sub-component;
retracting the pin locators so as to allow the thermoplastic coating to flow into spaces previously occupied by the pin locators; and
removing the at least partially encapsulated structural sub-component from the tooling cavity of the second mold,
the steps of inserting the structural sub-component into the tooling cavity of the second mold, spacing the structural sub-component form the internal sides of the second mold, injecting the thermoplastic coating, allowing the thermoplastic coating to solidify, retracting the pin locators, and removing the at least partially encapsulated structural sub-component being performed in less than 40 seconds.

21. A method of forming a part of a head and neck support device, the method comprising the steps of:
melting a supply of corrosive chipped magnesium alloy to a semi-solid state of between 0.01 percent to 30 percent solid;
injecting the corrosive magnesium into a tooling cavity of a first mold while the corrosive magnesium metal is in the semi-solid state, the first mold being shaped to form a desired outer shape of a corrosive metal core of the head and neck support device;
cooling the corrosive magnesium to a solid state so as to form a structural sub-component of the head and neck support device;
inserting the structural sub-component into a tooling cavity of a second mold shaped to form a desired outer shape of the head and neck support device;
spacing the structural sub-component from internal sides of the second mold so as to form a gap between the structural sub-component and the internal sides of the second mold;
holding the structural sub-component via pin locators;
injecting a thermoplastic coating into the gap so as to form a chemically inert, non-structural shell at least partially encapsulating the structural sub-component;
allowing the thermoplastic coating to solidify around the structural sub-component;
retracting the pin locators so as to allow the thermoplastic coating to flow into spaces previously occupied by the pin locators; and
removing the at least partially encapsulated structural sub-component from the tooling cavity of the second mold,
the steps of inserting the structural sub-component into the tooling cavity of the second mold, spacing the structural sub-component form the internal sides of the second mold, injecting the thermoplastic coating, allowing the thermoplastic coating to solidify, retracting the pin locators, and removing the at least partially encapsulated structural sub-component being performed in less than 40 seconds.
